(19) United States
(12) Patent Application Publication
(10) Pub. No.: US 2023/0400860 A1
(43) Pub. Date: Dec. 14, 2023

(54) ENABLING MOBILE ROBOTS FOR AUTONOMOUS MISSIONS

(71) Applicant: Board of Supervisors of Louisiana State University and Agricultural and Mechanical College, Baton Rouge, LA (US)

(72) Inventor: Jonathan Shi, Baton Rouge, LA (US)

(21) Appl. No.: 18/331,466

(22) Filed: Jun. 8, 2023

Related U.S. Application Data
(60) Provisional application No. 63/350,629, filed on Jun. 9, 2022.

(51) Int. Cl. G05D 1/02; G01C 21/00

(52) U.S. Cl. CPC G05D 1/0214; G05D 1/0291; G01C 21/383

(57) ABSTRACT

System and methods for enabling a mobile robot for autonomous missions are described. Despite some mobile robots having the capability of safely traversing complex terrains, mobile robots still behave like a typical machine which can only respond to a human's commands via an interactive controller. For example, a human will drive the mobile robot to desired locations, position it, and activate actions as desired in order to complete a mission. As such, it is desirable to enable a mobile robot with the capability of executing and completing a mission without a human's involvement. The present disclosures includes innovative technology which enables an ordinary user to quickly define a complex mission in the form that a mobile robot can understand and automatically execute it accordingly.

### CROSS REFERENCE TO RELATED APPLICATIONS

This application claims the benefit of, and priority to, U.S. Provisional Application No. 63/350,629, entitled “ENABLING MOBILE ROBOTS FOR AUTONOMOUS MISSIONS” and filed Jun. 9, 2022, which is hereby incorporated by reference in its entirety.

### BACKGROUND

Mobile robot technology has made terrific advancement in recent years such as safely traversing complex terrains including stairs. However, mobile robots still behave like a typical “machine” most of the time relying on a human's commands via a controller. In order to complete a complex mission, a human provides constant instructions in real time for the robot to travel to the desired locations and activate desired actions. Accordingly, there is a need to enable a mobile robot with the capability of executing and completing a mission without a human's involvement.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a block diagram of an autonomous mission system architecture, according to one embodiment described herein.

FIG. 2 illustrates an example of a location-based map using the M-Map module, according to one embodiment described herein.

FIG. 3A is a flowchart illustrating one example of functionality implemented as portions of an application according to various embodiments of the present disclosure.

FIG. 3B illustrates an example user interface for creating a mission by using M-Mission module, according to one embodiment described herein.

FIG. 4A is a flowchart illustrating one example of functionality implemented as portions of an application according to various embodiments of the present disclosure.

FIG. 4B shows an example of the simulation and animation using M-Planning module according to various embodiments of the present disclosure.

FIG. 5 illustrates a mobile robot trajectory according to various embodiments of the present disclosure.

FIG. 6 shows the trajectory algorithm used by M-Execution according to various embodiments of the present disclosure.

FIG. 7A is a flowchart illustrating one example of functionality implemented as portions of an application according to various embodiments of the present disclosure.

FIG. 7B illustrates obstacle avoidance approach used by M-Execution according to various embodiments of the present disclosure.

FIG. 8 shows the use of infrared distance sensors for enhancing robot localization according to various embodiments of the present disclosure.

### DETAILED DESCRIPTION

The present disclosure relates to enabling a mobile robot for autonomous missions. Despite some mobile robots having terrific capability such as safely traversing complex terrains including stairs, mobile robots still behave like a typical “machine” which can only respond to a human's commands via an interactive controller. One non-limiting example of a mobile robot is Boston Dynamics's Spot®. A human will drive Spot to desired locations, position it, and activate actions as desired in order to complete a mission. As such, it is desirable to enable a mobile robot with the capability of executing and completing a mission without a human's involvement. The embodiments represent innovative technology which enables an ordinary user to quickly define a complex mission in the form that a mobile robot can understand and automatically execute it accordingly.

In search for automation, Spot comes with an impressive “AutoWalk” feature which allows a user to record a mission and then Spot can repeat the same mission without the user's involvement. Spot's AutoWalk function works as the following:
The user creates a mission by using its AutoWalk capability via the controller; The user then drives Spot to desired destinations and activates desired tasks at the destinations. The entire manually maneuvered process is recorded as the mission consisted of a detailed map and tasks. The map is consisted of waypoints, edges connecting two neighboring waypoints, and point clouds of the environment. The tasks are recorded at the corresponding waypoints of their executions.
Spot can repeat a mission starting with initializing its location on the map. With the recorded map, Spot can locate itself at a waypoint on the map, perform the desired tasks at the location, and navigate itself to the next waypoint by following the sequence on the recorded map.
   This functionality has at least two serious drawbacks: 1) the function is not applicable to a new environment without a recorded mission; and 2) repeating the same mission every time may have limited practical application in many industries since each mission tends to be unique including destinations and tasks to be performed at destinations; furthermore, the environment may change over time.

### 1 Justifications for Autonomous Mission for Mobile Robot

In order for a robot to be widely accepted for real world applications, it should add value via at least one of the following means: 1) replacing a human workforce, or 2) improving human productivity or efficiency. Traditional industrial robots have been widely installed in manufacturing environments to replace repetitive tasks which were performed by human. In recent years, autonomous mobile robots are used in warehousing and similar environment.

In a more complex scenario, a mobile robot can be expected to travel to a number of destinations and to perform certain tasks at these destinations. Although each mission is similar to other missions, it also has its uniqueness in terms of its desired destinations and tasks to be performed at the destinations. This is similar to Amazon delivery, which requires the driver to load up the ordered items at the warehouse and then to drive to the delivery addresses and to drop off the items according to the orders. For each delivery mission, the ordered items and delivery addressed are unique. In this case, the driver and the vehicle work together to fulfill the mission. In some embodiments, a fully autonomous delivery robot can have the following two key capabilities: 1) self-driving feature to navigate to the delivery destinations, and 2) self-loading and unloading feature to pick up the orders at the warehouse and to drop them off at the destinations.

The embodiments of the present disclosure enable mobile robots for fully autonomous missions. When a mobile robot is enabled with the autonomous functionality, it will be cost-effective for the mobile robot to be widely used in several industrial applications, for example, such as:
Inspections. Mobile robots can travel to desired locations and take photos or scan the environment as desired. This type of application is common for several industries including construction and manufacturing.
Safety patrol and surveillance. Mobile robots can be scheduled for routine patrols or be sent to the site of an incidence to deliver messages and/or record the incidence. This type of application is common for safety and security management of large facilities such as plants or campuses.
   Accordingly, the embodiments of the present disclosure enable mobile robots to be used in various applications.

### 2 Autonomous Mission System (Auto-M)

In order to enable a mobile robot for autonomous mission, the first challenge is to develop a universal structure for representing complex missions. The structure can be easy to use and rigorous at the same time to allow an ordinary user to quickly describe what is expected for the robot to do; in the meantime, the representation can be fully understood and executed by the robot accordingly.

### 2.1 Mission Configuration

In general, a mission can be defined as for the robot to traverse to n destinations in a given area and perform desired tasks at each destination as the following:

M={(D₁,T₁), . . . ,(D₁,T₁), . . . ,(Dₙ,Tₙ)} (1)=

Dᵢ={d₁,d₂, . . . ,d_{f}} (2)

Tᵢ={t₁,t₂, . . . ,tₚ} (3)

### Where,

Dᵢ—destination i, which can be identified by a set of features {d₁, d₂, . . . , d_{f}}, such as coordinates, address, and landmark photo;
Tᵢ—set of tasks {t₁, t₂, . . . , tₚ} to be performed at destination Dᵢ, such as taking a photo and playing a sound.

Equations 1-3 refer to two capabilities: 1) navigation, and 2) action. Although mobility is the common given feature of a mobile robot, the navigation capability can enable the robot to correctly locate itself and safely move to desired destinations. Maps have been widely used in daily life. Similarly, a location based map can be used to identify the desired destinations in a robot mission. The remaining challenge is how to build the map so that the robot can understand it, locate itself on the map, and find a path to move to the desired destinations in the given mission.

The action capability refers to tasks that the robot can perform. Most mobile robots are embedded with camera, microphone, lighting, and speaker. Hence, example tasks can include taking photo, recording video, playing audio, lighting, and other suitable mobile robot tasks. However, the installed hardware components vary significantly from robot to robot. For instance, DJI RoboMaster has a monocular camera, but Spot has 5 pairs of depth cameras in its base with optional SpotCam. Moreover, optional sensors or hardware may also be attached to some robots. For instance, Spot's capability can be expanded with a robotic arm. DJI RoboMaster may be attached with infrared distance sensors (IR). As technology advances, more sensors and hardware components become available to expand mobile robot capabilities, leading to more and more tasks.

### 2.2 System Architecture

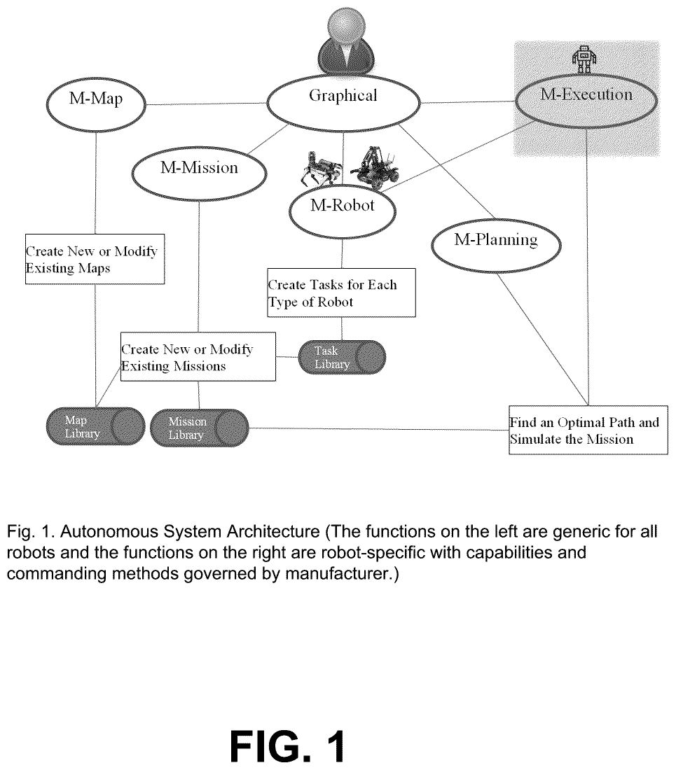

The Auto-Mission system is an integrated computer system which works as an application for the user to create and manage autonomous missions and also as an agent for the user to deploy and control mobile robots for various autonomous missions without the user's direct engagement. Auto-Mission is an interface between a mobile robot (e.g., like Boston Dynamics Spot) and the user. FIG. 1 illustrates an autonomous system architecture. The functions on the left can be applicable to all or a majority of mobile robots from different manufacturers. The function on the right can be robot-specific with capabilities and commanding methods governed by a robot manufacturer. As shown in FIG. 1, the user can use a graphical user interface (GUI) to access and manage the following five function modules:
M-Map. This module enables the user to construct new location-based maps, modify and manage existing maps for robot missions.
M-Mission. This module allows the user to create new missions by selecting desired destinations from a location-based map and desired tasks at these destinations, and to modify existing missions in the library.
M-Robot. This module allows the user to manage a pool of mobile robots including different types of robots, e.g., Spot and DJI RoboMaster. The user can select a particular robot to execute a mission.
M-Planning. This module enables the user to load a mission from the mission library to experiment with it including searching for an optimal path and simulate the mission on the computer by animating the robot's movement along the selected path throughout the mission.
M-Execution. This module puts a robot in action. It serves as an agent to assign a robot from the robot pool on the mission.
   The following sections provide a more detailed description of these function modules. Various implementations may include one or more of the following modules.

### 2.3 Functional Modules

### 2.3.1 Location-Based Map, M-Map

Maps for robots can be classified into two categories: 1) local map, and 2) global map. A local map can guide the robot's strategy how to move safely toward its next destination. A global map here can refer to an area that the robot will be commissioned with autonomous missions, such as a construction site or a community. A global map is similar to a traffic map showing available roads in a region. A mobile robot can rely on a global map to plan its navigation strategy to travel to the desired destinations as specified in the mission.

A semantic location-based map is adopted in this invention as for robot navigation. A location-based metric map can include unique points of interest (POIs) and connecting edges. In addition to using coordinates for locating a POI, its location may also be characterized by features, such as room number or landmark pictures (e.g., April sign, picture, etc.). In order to use landmark features for localization, the robot can have image processing and object detection capabilities. An edge indicates accessibility between two POIs.

The embodiments of the present disclosure includes development of an API for the user to create a location-based map. A map can be created from an existing digital map, a floor plan or a construction site layout. A POI is labeled by a unique ID number and detailed by its coordinates, Dᵢ(x, y, z) in the 3-demssional space, with z representing elevation or relative height. If all POIs are on the same plane, their z value can be set to zero. A robot may use different travel modes corresponding to the elevation differences between two connected POIs, such as, climbing stairs or slopes.

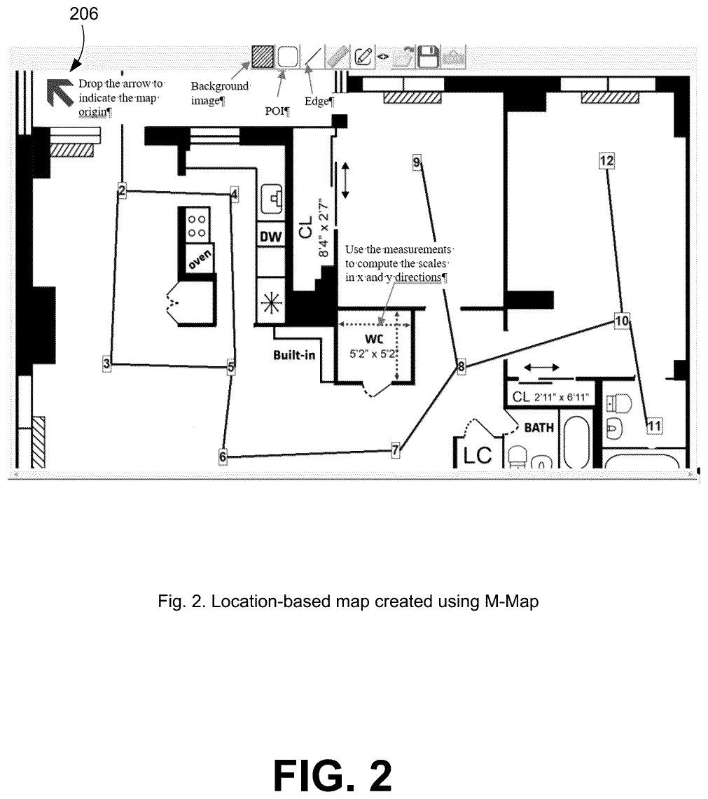

An example location-based map as shown in FIG. 2 is created on top of a building floor plan. Creating the map involves the following steps: 1) loading a background image, 2) placing POIs at desired locations on the image, and 3) connecting accessible POIs as edges.

In addition, the user can drag and drop the arrow 206 to indicate the origin (0,0) of the map coordinate system. For computing the coordinates of POIs and lengths of the edges, a ruler tool is implemented for the user to measure the dimensions of one space, e.g., the 5′2″×5′2″ bathroom in the example. Then, M-Map computes the horizontal and vertical scales which are used to convert the pixels to actual measurements as the coordinates of the POIs and to compute the distances of the edges by using the following Eqs:

$$\begin{matrix}{S}_{x} = \frac{W}{{P}_{x}} & ( 4 ) \\ {S}_{y} = \frac{H}{{P}_{y}} & ( 5 ) \\ {I}_{x}^{′} = ( {I}_{x} - {O}_{x} ) {S}_{x} & ( 6 ) \\ {I}_{y}^{′} = ( {I}_{y} - {O}_{y} ) {S}_{y} & ( 7 ) \\ {d}_{I , J} = \sqrt{{( {I}_{x -}^{′} {J}_{x}^{′} )}^{2} + {( {I}_{y -}^{′} {J}_{y}^{′} )}^{2}} & ( 8 )\end{matrix}$$

Where, W and H are the actual width and height of the space; Sₓ is the horizontal scale; S_{y} is the vertical scale; Pₓ is the width (W) measured in pixels; and P_{y} is the height (H) measured in pixels; (Oₓ, O_{y}) are the coordinates of the origin measured in pixels; (Iₓ, I_{y}) are the coordinates of POI “I” measured in pixels; (I′ₓ, I′_{y}) are the coordinates of POI “I” measured in real dimension; and d_{I,J} is the distance between destinations “I” and “J”.

The M-Map module also provides editing tools for the user: 1) to drag a POI and drop at another location, 2) to add new POIs or delete existing POIs, and 3) to add new edges and modify existing edges. As shown FIG. 2, a location-based map was constructed from a building floor plan. In the drawing, the 12 POIs as shown indicate potential destinations for creating missions. The connection lines between two adjacent POIs represent the edges that a robot can traverse between them. If there is no direct connection between two POIs (such as, between 2 and 5), then the robot can find a path (such as, 2-3-5 or 2-4-5).

### 2.3.2 Mission Management, M-Mission

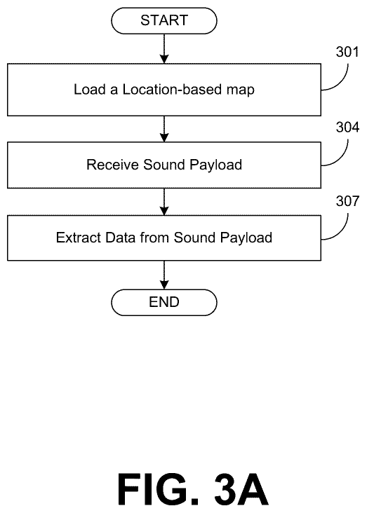

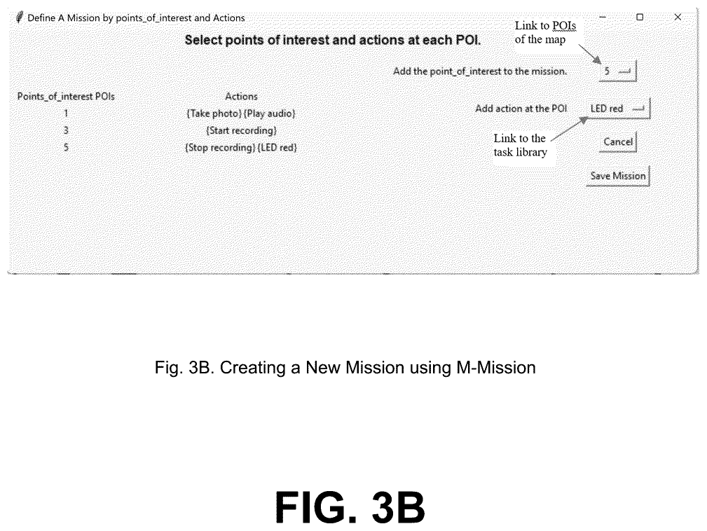

This module can provide an API for the user to create new missions by selecting desired destinations from a location-based map and desired tasks at these destinations, and to manage existing missions in the library by adding/removing destinations and adding/removing tasks at the destinations. As shown in FIG. 3A, creating a new mission can involve the following steps:
Step 1 (301). load a location-based map from the map library,
Step 2 (304). select destinations one at a time from the POIs in the map; and
Step 3 (307). select desired tasks at each destination from the task library.

FIG. 3B shows the interface for the user to create a new mission. After a map is loaded, the “POI” button on the top right links to the POIs in the loaded map. Clicking on the button allows the user to add a POI as a destination to the mission. After a destination is selected, the user can click on the “action” button underneath the “POI” button to select actions to the mission one at a time. The “action” button is linked to the task library for the given robot.

FIG. 3B shows an example mission for the same location map as shown in FIG. 2. The mission calls for a robot to travel to three destinations 1, 3, and 5. The desired actions include: “Take photo” and “Play audio” at 1, “Start recording” at 3, “Stop recording” and “Flash LED” red light at 5.

M-Mission module allows multiple missions to be created from the same map and to create a new mission from modifying an existing mission. In summary, the user can use the API to create new missions and manage existing missions.

### 2.3.3 Robot Tasks, M-Robot

Fulfilling a mission can involve a robot performing one or a series of tasks at each destination. What tasks that a robot can perform in general is limited by its designed capability and assembly. Today's robots can only perform limited number of tasks. More tasks can be added as additional apparatus and/or sensors are attached to the mobile robot base. As a non-limiting example, a task library can be developed as the following:

$$Robot\_actions = \{ \\ ‘ Take photo ’ , \\ ‘ Start recording ’ , \\ ‘ Play audio ’ , \\ ‘ LED green ’ , \\ ‘ LED red ’ , \\ … \\ \}$$

The task library can be expanded over time as more tasks become available to the given robot. Moreover, in order for the robot to automatically perform a task while the robot is on its mission, a proper function can be developed for the given robot. As of today, most robots use their own commands or methods to activate various actions. For instance, Spot requires initiating a client before calling any service. On the other hand, DJI RoboMaster can directly use a command to take a photo, or to start or stop recording a video stream. Therefore, separate functions can be developed for each type of robot in the pool of the robots.

The embodiments can be used to instruct mobile robots of different types to complete autonomous missions. For example, two different types of mobile robots can include the Boston Dynamics Spot and DJI RoboMaster EP. Other mobile robots can be instructed to perform an autonomous mission.

2.3.4 Mission Planning, M-Planning

If a mission involves multiple destinations, the robot may travel to them in different orders, leading to multiple feasible paths for the mission. Ideally, an optimal path should be selected. Therefore, after a mission is defined, the robot should act like a human by figuring out a plan first before starting its first move. M-planning is to determine an optimal path with which the robot, starting from its initial location, traverses to all the desired destinations in the mission under the conditions and constraints of the location-based map (M-Map).

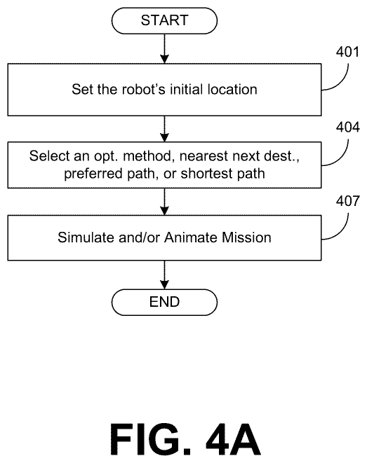

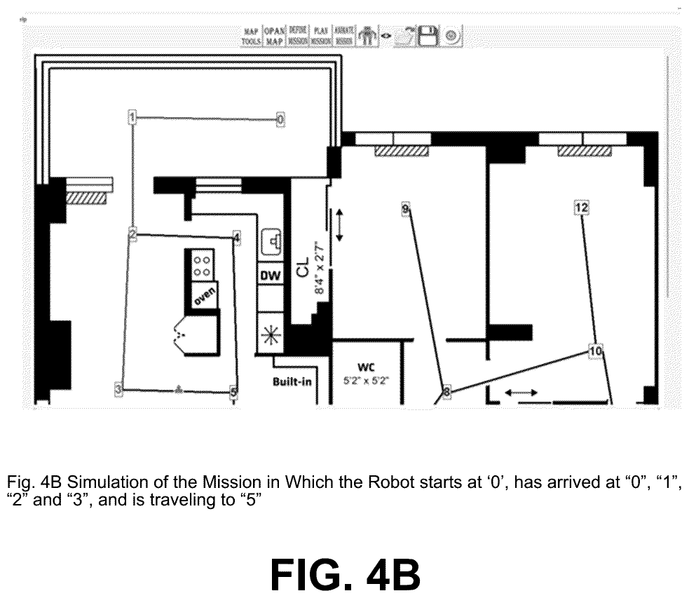

Numerous optimization methods are available for finding an optimal path (e.g., a planned path), for example: 1) nearest next destination; 2) preferred path by the user; and 3) shortest path which has the shortest total travel distance or least cost. As shown in FIG. 4A, M-Planning can involve the following steps”:
Step 1 (401): Set the robot's initial location for the mission by placing a robot at a POI;
Step 2 (404): Select an optimization method, nearest next destination, preferred path, or shortest path;
Step 3 (407): Simulation and animation of the mission on the computer as shown in FIG. 4B.

It should be noted that many optimization algorithms are available in the public domain and can be added if needed.

2.3.5 Mission execution, M-Execution

An autonomous mission requires the robot to self-guide from its initial destination to all the desired destinations along the selected optimal path obtained above and to perform all the desired tasks without the user's direct engagement. M-Execution involves three key functions: 1) Self-navigation, 2) Self-activation of tasks, and 3) Monitoring and reporting of robot mission status. The M-Execution can be a robot application that is executed by the mobile robot.

### 2.3.5.1 Navigation

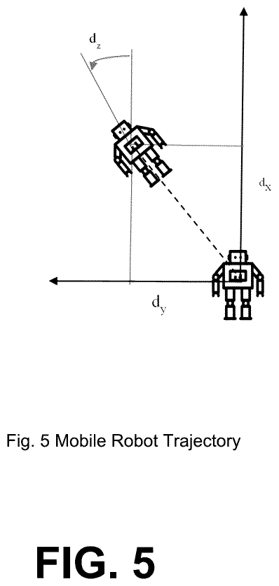

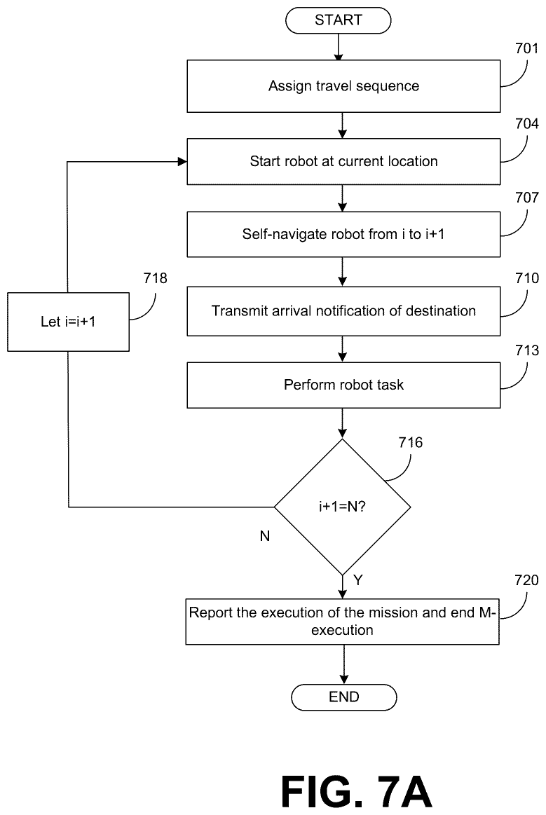

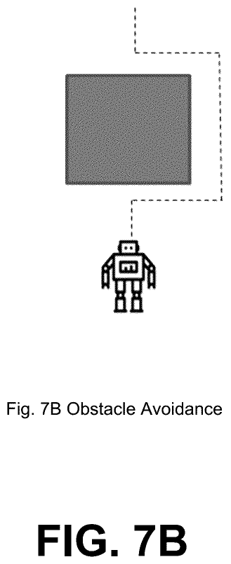

The number of destinations of the given mission is assumed as N. As shown in FIG. 7A, the navigation algorithms can involve the following steps:
Step 1 (701). Assign the travel sequence as [1, 2, . . . N] with “1” indicating the initial POI of the robot and “N” as the final POI at the end of the robot mission. Set the robot current location to “1”.
Step 2 (704). Let the robot start=robot current location with its coordinates as (xᵢ, yᵢ, zᵢ)
Step 3 (707). Navigate the robot from i to i+1 with coordinates as (xᵢ₊₁, yᵢ₊₁, zᵢ₊₁). Mobile robots can use three relative movements to determine its trajectory as shown in FIG. 5, in which dₓ and d_{y} show its relative movements between its new position and its start position. A positive dₓ indicates a forward movement. A positive d_{y} indicates a relative movement to the left. A positive d a indicates a counter-clock wise rotation of the robot at the end of the move comparing to its start orientation. Compute the relative movements for the robot to move from i to i+1 as the following:

dₓ=xᵢ₊₁−xᵢ (9)

d_{y}=yᵢ₊₁−yᵢ (10)

d_{z}=zᵢ₊₁−zᵢ (11)

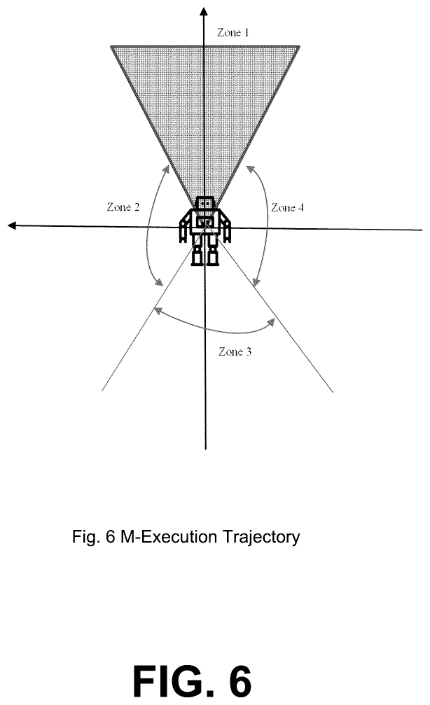

In order to better monitor and track robot movement and orientation, the navigation algorithm rotates the robot only by +/−90° or 180°. As illustrated in FIG. 6 with “i” as the start, if “i+1” isn't located in the shaded zone 1, a rotation (90°, −90°, or 180°) is performed for the robot coordinate system,

θ=r*90° (12)

where, r is a multiplier, r=0 if i+1 falls in Zone 1; r=1 if i+1 falls in Zone 2; r=2 if i+1 falls in Zone 3; r=−1 if i+1 falls in Zone 4. After the rotation, the robot moves only forward as the following:

$$\begin{matrix}[ \begin{matrix}{d}_{x}^{′} \\ {d}_{y}^{′}\end{matrix} ] = [ \begin{matrix}cos θ & sin θ \\ - sin θ & cos θ\end{matrix} ] [ \begin{matrix}{d}_{x} \\ {d}_{y}\end{matrix} ] & ( 13 ) \\ move ( {d}_{x}^{′} , {d}_{y}^{′} , mode ) & ( 14 )\end{matrix}$$

where the robot's moving mode may be determined by the elevation difference, d′_{z}. If both “i” and “i+1” are at the same elevation, d_{z}=0, a normal travel mode is used; otherwise, a special travel mode for stairs or slope can be used for the segment of the path.
Step 4 (710). A notification of arrival at the destination is sent after the robot arrives at “i+1”; otherwise, refer the following paragraph for obstacle avoidance for detail.
Step 5 (713). Refer 2.3.5.4 Performing robot tasks for detail.
Step 6 (716). If i+1=N, go to Step 7; otherwise, let i=i+1 (718), repeat
Steps 2 to 6.
Step 7 (720). Report the execution of the mission and end M-execution. Refer 2.3.5.3 localization for updating the robot's location, and refer 2.3.5.4 performing robot tasks for updating the status of the tasks.

### 2.3.5.2 Obstacle Avoidance

While moving from “i” and “i+1”, a robot may encounter obstacles. A connecting edge between two destinations indicates an accessible path between them although obstacles may lie between them. Spot can detect an obstacle on its way with its embedded sensors. If the obstacle is small, Spot can get around it by itself. Infrared distances sensors can be added to DJI RoboMaster to detect the obstacle. As shown in FIG. 7, the robot attempts to move to the right and get around the obstacle. After passing the obstacle, the robot returns to its planned path. If the robot cannot find a path on the right, it then attempts on the left. If both right and left attempts fail, the robot would send a notification of the failed destination, skip it, and continue its mission.

### 2.3.5.3 Localization

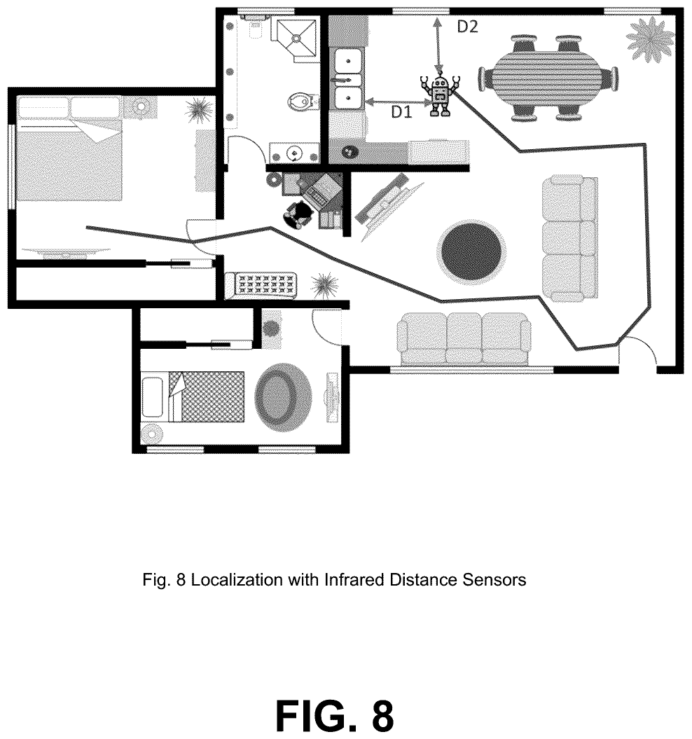

Mobile robots can use their internal odometry and other sensors to estimate their position in the real world. The estimation can be enhanced by advanced inertial navigation systems and advanced sensors (e.g., infrared distance sensors, depth cameras, and lidar). Realtime sensed environment data from the cameras and Lidar (point cloud data) can assist the robot in estimating and calibrating its current position. As shown in FIG. 8, two infrared distance sensors are attached to DJI RoboMaster to calibrate its position while in the mission. The obtained localization data can be plotted back on the mission map to show the planned path vs. the actual traveled path of the robot.

### 2.3.5.4 Performing Robot Tasks

An autonomous mission requires the robot to trigger the desired tasks when it arrives at a destination. The embodiments include function submodules for triggering M-Robot tasks for Spot and DJI Robomaster. Performing a task may require certain conditions. For instance, taking a photo may need a target or viewpoint selected. The robot can make adjustments in order to perform task based at least in part on one or more environmental conditions (. For example, the robot may need to adjust its location around the destination in order to properly perform a task. For instance, if laser scanning is to be conducted, it should avoid being blocked. There are many challenges to be addressed. Sensed environment data including Lidar (point cloud data) can be used to assist the robot in performing the tasks in a similar fashion like a human would decide how to properly perform a task after considering the environmental conditions around the location.

In some embodiments, a method and solution of representing and executing an autonomous mission for mobile robots is described. For example, the method can include providing, via a computing device associated with a mobile robot, an algorithm and solution to represent complex missions for autonomous mobile robots. The autonomous mission can comprise a plurality of destination locations for the mobile robot to visit in an area and at least one task to be performed at each of the plurality of destination locations. The method can include creating, via the computing device, a location-based map from an existing digital drawing, such as, a floor plan or a site layout. The resulting map can be correctly scaled to the same real world dimensions of the background image. The method can include planning, via the computing device, an optimal path for the mobile robot to travel to the plurality of destination locations based at least in on part of the location-based map for the autonomous mission and self-navigating, via the computing device, the mobile robot from the current location to the plurality of desired destination locations along the planned path.

Further, the method can include automatically triggering, via the computing device, the mobile robot to perform the at least one task based at least in part on the mobile robot arriving at the respective location and acting, via the computing device, as an agent to manage the mobile robot on the mission, monitoring and reporting the progress and status of the mission.

Additionally, the method can include a solution for the user to create, by the computing device, the location-based map for the plurality of destination locations. The location-based map can include a digital map of the area, a plurality of points of interest (POIs), and a plurality of connecting edges. Each of the plurality of connecting edges indicates a path between two POIs. The map provides the accurate spatial reference for the user to quickly create a mission based on where the robot should be sent and what should be done. Moreover, the map allows the robot to locate where it is now and where it should navigate to next.

Each of the plurality of POIs is represented by a set of coordinates. Based on where the POIs are placed on the background image and the background's embedded scales, the real world dimensions of the coordinates are computed. The method can further include planning, via the computing device, an optimal path for the mobile robot to travel to the plurality of destination locations based at least in on part of the location-based map for the autonomous mission and simulating and animating, via the computing device, the mission on the computer prior to its execution. This function enables the user to experiment with multiple scenarios prior to sending the robot on a mission in the field.

The navigation of the mobile robot from its initial location to final location can further include a generic algorithm, via the computing device, to divide the entire path into segments between the current and next destinations. A trajectory strategy, via the computing device, that enables the robot to rotate itself can be included based on its current orientation and maintain a proper orientation to move forward to its next desired destination. The navigation of the mobile robot can include a navigation strategy, via the computing device, that enables the robot to move from its current destination to next desired destination.

Further, the navigation of the mobile robot from the current location to the next location can further include identifying, via the computing device, an obstacle in proximity on the planned path using a sensor of the mobile robot and determining, via the computing device, an alternative path for the mobile robot to avoid the obstacle.

The automatic initiation of the mobile robot to perform the at least one task can further include accessing a task library that includes a plurality of code blocks or a plurality of submodules for execution by the mobile robot for a respective task with the selected robot. The autonomous mission system (Auto-Mission) can further include an application (API) for the user to quickly create and manage autonomous missions for mobile robots. An interface between a human user and a mobile robot and a software agent to execute and monitor a mobile robot on an autonomous mission can be included.

In some embodiments, a system for instructing an autonomous mobile robot can include at least one computing device that comprises a processor and memory. The system can include an application executable in the at least one computing device. When executed, the application causes the at least one computing device to at least receive a request to generate an autonomous mission for a mobile robot and generate a location-based map for the autonomous mission based at least in part on a digital image of an area layout. The location-based map is generated by scaling the digital image of the area layout based at least in part on a dimension identified in the area layout.

A planned path of the autonomous mission for the mobile robot is determined and instructs the mobile robot to travel to the plurality of destination locations based at least in part on a first entry of a plurality of destination locations for the area layout and a second entry of at least one task to be performed at a respective destination of the plurality of destination locations from a user interface. The mobile robot is instructed to self-navigate the planned path of the autonomous mission and to perform the at least one task at the respective destination.

The application, when executed by the processor, causes the at least one computing device to at least update the user interface to display a status of the mobile robot along the planned path of the autonomous mission. The location-based map can include a plurality of points of interest (POIs) and a plurality of connecting edges. Each of the plurality of connecting edges can indicate a path between two POIs. The location-based map comprise a spatial reference that indicates a direction for the mobile robot to be sent next and a respective task to be completed. The plurality of POIs is represented by a set of coordinates based at least in part on a respective location of the POIs.

The application, when executed by the processor, causes the at least one computing device to at least animate in the user interface the mobile robot executing the autonomous mission prior to instructing the mobile robot to self-navigate to the planned path. The application, when executed by the processor, can cause the at least one computing device to divide the planned path into a plurality of segments between a current location of the mobile robot and a next destination location. The application, when executed by the processor, can cause the at least one computing device to generate a trajectory strategy to enable the mobile robot to rotate itself based on a current orientation and maintain a proper orientation to move forward to a next desired destination and to generate a navigation strategy to enable the mobile robot to move from a current destination to a next desired destination.

The application can cause the at least one computing device to at least identify a robot type selected, via the user interface, for instructing to self-navigate the planned path. The selected robot type can be used determine set of application programming interfaces for communicating the autonomous mission.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method of executing an autonomous mission for a mobile robot, comprising:
providing, via a computing device associated with a mobile robot, an application for generating an autonomous mission for a plurality of autonomous mobile robots, the autonomous mission comprising a plurality of destination locations for the mobile robot to visit in an area and at least one task to be performed at each of the plurality of destination locations;
creating, via the computing device, a location-based map based at least in part on a digital background image of a floor layout plan, a local map, or a site layout plan, wherein the location-based map is created by scaling to the digital background image;
determining, via the computing device, a planned path for the mobile robot to travel to the plurality of destination locations based at least in part on the location-based map for the autonomous mission;
instructing, via the computing device, a mobile robot to self-navigate from a current location to the plurality of desired destination locations along the planned path; and
instructing, via the computing device, the mobile robot to automatically perform the at least one task based at least in part on the mobile robot arriving at one of the plurality of destination locations.

2. The method of claim 1, further comprising:
executing, via the computing device, a software agent to manage the mobile robot on the autonomous mission, wherein the software agent comprises monitoring and reporting a progress and status of the autonomous mission.

3. The method of claim 1, wherein the location-based map comprises a plurality of points of interest (POIs) and a plurality of connecting edges, wherein each of the plurality of connecting edges indicates a path between two POIs.

4. The method of claim 3, wherein the location-based map comprises a spatial reference that indicates a direction for the mobile robot to be sent to and respective tasks to be completed.

5. The method of claim 3, each of the plurality of POIs is represented by a set of coordinates based at least in part on a respective location of the POIs in the digital image and an embedded scale for the digital image.

6. The method of claim 1, further comprising:
simulating, via the computing device, the autonomous mission on a computer prior to instructing the mobile robot to the mission.

7. The method of claim 1, wherein instructing the mobile robot to self-navigate further comprises:
executing, a feature of the application, via the computing device, to divide the planned path into a plurality of segments between the current location and a next destination location, wherein the feature comprises determining at least:
a trajectory strategy, via the computing device, to enable the mobile robot to rotate itself based on a current orientation and maintain a proper orientation to move forward to a next desired destination; and
a navigation strategy, via the computing device, to enable the mobile robot to move from a current destination to a next desired destination.

8. The method of claim 7, wherein instructing the mobile robot to self-navigate further causes the mobile robot to at least:
identify an obstacle in proximity on the planned path using a sensor of the mobile robot; and
determine an alternative path for the mobile robot to avoid the obstacle.

9. The method of claim 1, wherein instructing the mobile robot to automatically perform the at least one task further comprising:
accessing a task library that includes a plurality of code blocks or a plurality of submodules for execution by the mobile robot for a respective task with the mobile robot.

10. The method of claim 1, wherein the application comprises:
an application programming interface (API) for creating and managing a plurality of autonomous missions for a respective mobile robot;
a user interface that is used to generate an instruction to the API for creating and managing the plurality of autonomous missions; and
a software agent to execute and monitor the mobile robot on the autonomous mission.

11. A system for managing autonomous mobile robots, comprising:
at least one computing device that comprises a processor and memory; and
an application executable in the at least one computing device that, when executed by the processor, causes the at least one computing device to at least:
receive a request to generate an autonomous mission for a mobile robot;
generate a location-based map for the autonomous mission based at least in part on a digital image of an area layout, wherein the location-based map is generated by scaling the digital image of the area layout based at least in part on a dimension identified in the area layout;
determine a planned path of the autonomous mission for the mobile robot to travel to the plurality of destination locations based at least in part on a first entry of a plurality of destination locations for the area layout and a second entry of at least one task to be performed at a respective destination of the plurality of destination locations from a user interface; and
instruct the mobile robot to self-navigate along the planned path of the autonomous mission and to perform the at least one task at the respective destination.

12. The system of claim 11, wherein the application, when executed by the processor, causes the at least one computing device to at least:
update the user interface to display a status of the mobile robot along the planned path of the autonomous mission.

13. The system of claim 11, wherein the location-based map comprises a plurality of points of interest (POIs) and a plurality of connecting edges, wherein each of the plurality of connecting edges indicates a path between two POIs.

14. The system of claim 13, wherein the location-based map comprises a spatial reference that indicates a relative location for each of the POIs and distances between them in the universal M-Map coordinate system.

15. The system of claim 13, wherein the plurality of POIs is represented by a set of coordinates based at least in part on a respective location of the POIs.

16. The system of claim 11, wherein the application, when executed by the processor, causes the at least one computing device to at least:
simulate and animate a selected mission prior to instructing the mobile robot to execute the selected mission.

17. The system of claim 11, wherein instructing the mobile robot to self-navigate further causes the application, when executed by the processor, causes the at least one computing device to at least:
divide the planned path into a plurality of segments between a current location of the mobile robot and a next destination location.

18. The system of claim 17, wherein instructing the mobile robot to self-navigate further causes the application, when executed by the processor, causes the at least one computing device to at least:
generate a trajectory strategy to enable the mobile robot to rotate itself based on a current orientation and maintain a proper orientation to move forward to a next desired destination; and
generate a navigation strategy to enable the mobile robot to move from a current destination to a next desired destination.

19. The system of claim 111, wherein instructing the mobile robot to self-navigate further causes the application, when executed by the processor, causes the at least one computing device to at least:
identify a robot type selected, via the user interface, for instructing to self-navigate the planned path.

20. A mobile robot system for executing an autonomous mission, comprising:
a mobile robot;
at least one computing device that comprises a processor and memory;
an application executable in the at least one computing device that, when executed by the processor, causes the at least one computing device to at least:
receive an autonomous mission from a remote computing device, the autonomous mission comprising a plurality of destination locations on a location-based map and at least one task assigned to be performed at a respective destination location;
assign a travel sequence of the mobile robot based at least in part on the plurality of destination locations, wherein the travel sequence can comprise a current location of the mobile robot as an initial
navigate, the mobile robot, from a current location to a next destination of the plurality of destination locations in the location-based map; and
execute the at least one task at the respective destination location.
